(19) United States
(12) Patent Application Publication
(10) Pub. No.: US 2009/0061958 A1
(43) Pub. Date: Mar. 5, 2009

(54) Cell phone arm mount

(76) Inventor: Alan George Osgood, Lakebay, WA (US)

Correspondence Address: ALAN GEORGE OSGOOD, 2225 - 194 Ave KPS, Lakebay, WA, 98349, US

(21) Appl. No.: 11/897,653

(22) Filed: Aug. 30, 2007

(51) Int. Cl. H04M 1/02

(52) U.S. Cl. 455/575.3

(57) ABSTRACT

An arm mounting bracket provides means for mounting cell phones, cordless phone, PDA's, Palm Pilots, iPods, GPS units, mini computers or similar devices directly to a user's arm so that the phone or PDA can be used directly as mounted on the user's arm. The apparatus comprises one or two sets of brackets 11 or 21 that are attached to the phone, Palm Pilot, Blackberry, PDA, GPS unit, mini computer or similar device. The brackets may be either integrated into the device body 21 or may be attached to existing devices 11. Single piece 41 or multiple piece 42 armbands are secured to the brackets and to the user's arm. This allows the user to mount the device directly to his/her arm 13. The brackets and arm bands are so designed that the user can use the device visual display and data entry area while the device is attached to the user's arm.

### BACKGROUND OF THE INVENTION

1. The Field of the Invention

The present invention relates to permanently installed devices for holding or retaining a personal digital assistant (PDA), cellular phone or similar device to the arm of a user.

2. The Prior Art

Prior art for PDA and cellular phone holders for other similar sized electronic devices include:

8. U.S. Pat. No. 7,251,197 to Yoshida et al.
9. U.S. Pat. No. D541,179 to Ahlstrom
10. U.S. Pat. No. 7,234,010 to Gilmour
11. U.S. Pat. No. D493,280 to Tabata
12. U.S. Pat. No. D503,038 to Tabata
13. U.S. Pat. No. D536,867 to Sexson
14. U.S. Pat. No. D527,893 to Martz
15. U.S. Pat. No. D545,564 to Davis
16. U.S. Pat. No. 7,230,885 to Sakurazawa et al.
17. U.S. Pat. No. 6,892,880 to Nieves

U.S. Pat. No. 7,251,197 to Yoshida et al. discloses an arm mounted wrist-watch sized communication device with a ear piece and microphone. U.S. Pat. No. D541,179 to Ahlstrom discloses an arm mounted wrist-watch sized device that serves as a wrist watch, a wrist computer and a diving computer. U.S. Pat. No. 7,234,010 to Gilmour discloses a wrist-watch sized data storage device.

These devices are based on the assumption that cell phones, other communication devices and computers will evolve downward in size until they are the size of conventional wrist watches. This assumption may not hold true for many communication devices. The inventors research on computer screens demonstrated that increasing the size of a computer screen increases user productivity. Many users may decide that increased display size in more important than ultra-small communication devices.

Other inventors have disclosed apparatus that hold cell phone sized devices. U.S. Pat. Nos. D493,280 and D503,038 to Tabata disclose apparatus designed to hold a cell phone on a users wrist. U.S. Pat. No. D536,867 to Sexson discloses a bracket apparatus for holding a cell phone to a users wrist. U.S. Pat. No. D527,893 to Martz discloses an apparatus to holding a cell phone to a users leg.

All of these devices share two problems. (1) the cell phone must be taken out of the holder to be used. (2) They require the user to purchase and maintain a second apparatus for carrying the cell phone. U.S. Pat. No. D545,564 to Davis discloses an apparatus to holding a cell phone that allows the cell phone to rotated for use. This apparatus is based on the assumption that a cell phone would not be worn in the orientation in which it is used. This is probably not a valid assumption.

U.S. Pat. No. 7,230,885 to Sakurazawa et al. discloses a wrist-watch sized device that is composed of resin. The resin material is not required for most cell phones.

U.S. Pat. No. 6,892,880 to Nieves discloses an apparatus for mounting a PDA, or similar sized device to a hard surface. This apparatus does not provide for mounting a cell phone, PDA on a users arm. What is needed is a device for mounting a cell phone, cordless home, PDA, Palm Pilot, iPod, GPS unit, mini computer or similar sized electronic device directly to the users arm so that the device can be used as mounted on the user's arm.

### BRIEF SUMMARY OF THE INVENTION

The present invention relates to apparatus for mounting cell phones, cordless phone, PDA's, GPS units, mini computers or similar devices directly to a user's arm so that the cell phone or PDA can be used directly as mounted on the user's arm. The apparatus comprises one or two sets of brackets that are attached to the phone, PDA, Palm Pilot, Blackberry, iPod, GPS unit, mini computer or similar device. The brackets may be either integrated into the device body, or may be attached to existing devices. Armbands are secured to the brackets and to the user's arm. This allows the user to mount the device directly to his/her arm. The brackets and arm bands are so designed that the user can use the device display segment and data entry segment while the device is attached to the user's arm.

### BRIEF DESCRIPTION OF THE SEVERAL VIEWS OF THE DRAWINGS

FIG. 1 shows an exploded view of a cell phone and attachable arm mounting brackets for the phone.

FIG. 2 shows a view of a cell phone with arm mounting brackets attached directly to the phone.

FIG. 3 shows an exploded view of a PDA and attachable arm mounting brackets for the PDA.

FIG. 4 shows a view of a PDA with arm mounting brackets attached directly to the PDA.

### REFERENCE NUMERALS IN FIGS

11—Attachable arm mounting bracket
12—Attaching surface for attachable arm mounting bracket
21—Permanently attached arm mounting bracket
31—Armband holder section of bracket without removable pin
32—Armband holder section of bracket with removable pin
33—Pin in arm mounting bracket for attaching armband
41—Single piece armband
42—Multiple piece armband
51—Cell phone
52—Cell phone body
54—Cell phone flip-open cover
55—Cell phone visual display
56—Cell phone earpiece
57—Cell phone mouthpiece
61—PDA
62—PDA body
64—PDA flip-open cover
65—PDA visual display
66—PDA earpiece
67—PDA mouthpiece
71—User's arm
72—User's hand
73—User's head
74—User's ear
75—User's mouth

### DETAILED DESCRIPTION OF THE INVENTION

Reference is now made to the drawings wherein like parts are designated with like numerals throughout.

Watches are commonly worn on user's arms (wrist watch). Currently wrist watch displays have displays of approximately the same height and width. The wrist watch display height and width commonly range from ¾ inch to 1¼ inch in size. However, cell phones, cordless phones, PDAs, Palm Pilots, Blackberrys, GPS units, mini computers and similar devices are not commonly worn on a user's arm. These devices are normally carried in pockets, or holsters or are mounted in fixed holders. Typically users must retrieve these devices from their pocket, holster or fixed mount in order to see the displays. These devices could be down sized to the size of a wristwatch. However this would make their displays extremely small and difficult to use. The current inventors research on computer displays had demonstrated that larger displays are more usable and enhance productivity relative to smaller displays. In order to support usability cell phones, cordless phones, PDA's, Palm Pilots, Blackberrys, GPS units, mini computers and similar devices will probably continue to be of the same approximate size and they are currently. Cell phones typically have a greater height than width. Cell phone heights are usually greater than their widths. Cell phone heights range from around 3 inches to around 4 inches. Cell phone widths typically range from 1½ inch to 2 inches. Cordless phones typically have a greater height than width. Cordless phone heights range from around 4 inches to around 8 inches. Cell phone widths typically range from 1½ inch to 2 inches. PDA's typically have a different height than width. PDA heights range from around 3 inches to around 8 inches. PDA widths typically range from 4 inch to 8 inches. Handheld GPS units typically have a different height than width. Handheld GPS unit heights range from around 3 inches to around 8 inches. Handheld GPS unit widths typically range from 3 inch to 8 inches.

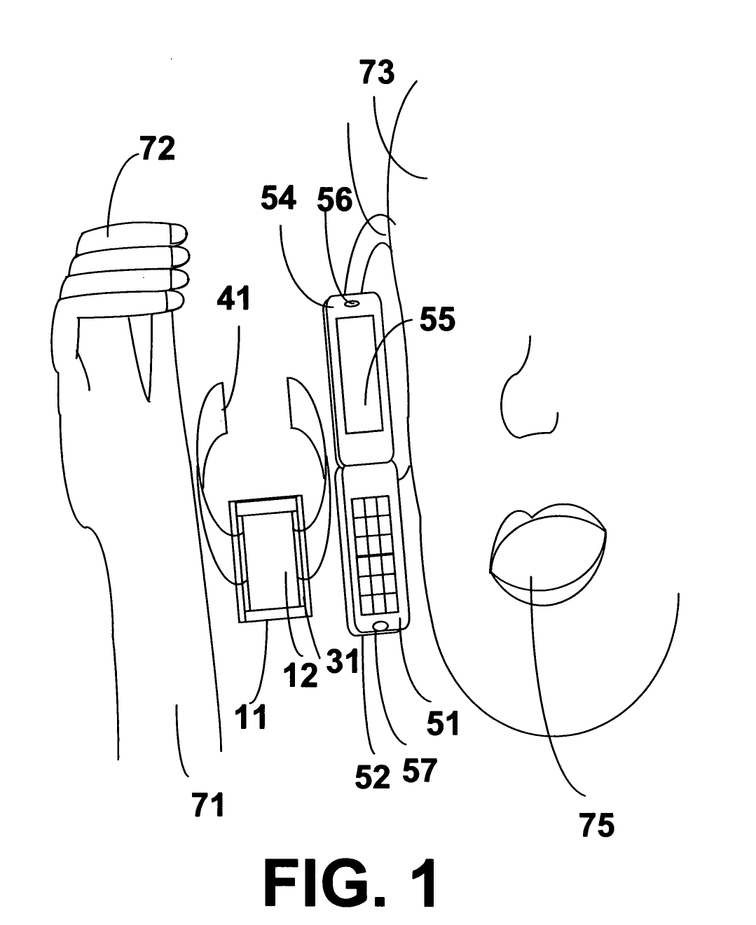

The present invention pertains to mechanisms for holding cell phones, cordless phones, PDA's, GPS units, mini computers and sized similar devices to a user's arm. FIG. 1 shows an exploded view of a cell phone 51 with an attachable bracket 11 for mounting the cell phone to the users arm 71. The attachable bracket 11 can be secured to the cell phone 51 back side by means of the attaching surface of the attachable arm-mounting bracket 12. The bracket 11 can be attached to the back-side of the cell phone 51 by either double-sided adhesive tape, or by epoxy or some other form of glue. This avoids interference with the buttons and data attach points on the sides of the cell phone. The single piece arm-band 41 is secured directly to the attachable armband bracket 11. The arm band holders 31 in the bracket 11 are designed without removable pins for securing the single piece arm band 41. The hook and loop fasteners of the single piece arm band 41 allow for sizing the arm band to the user. The cell phone may be worn on the inside of the user's arm 71 near the wrist with the cell phone height aligned with the length of the user's arm to protect the cell phone and allow for ease of use. FIG. 1 shows that the user can use the cell phone by opening the flip-open cover of the cell phone 54 and placing his/her arm 71 next to his/her head 72 so the ear piece 56 and mouthpiece 57 are properly positioned for use next to the user's ear and mouth respectfully.

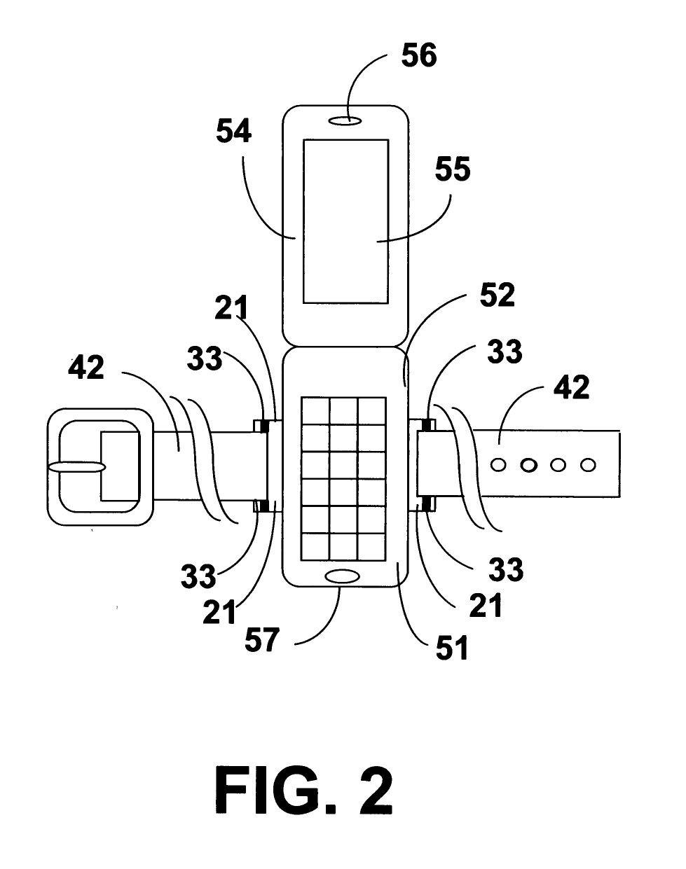

FIG. 2 shows a view of a cell phone 51 with arm mounting brackets 21 attached directly to the phone 51. The arm band holders 32 in the permanently attached armband bracket 21 are designed with removable pins to secure the multiple piece armband 42. The multiple piece arm band 42 secures the cell phone to the user's arm 71.

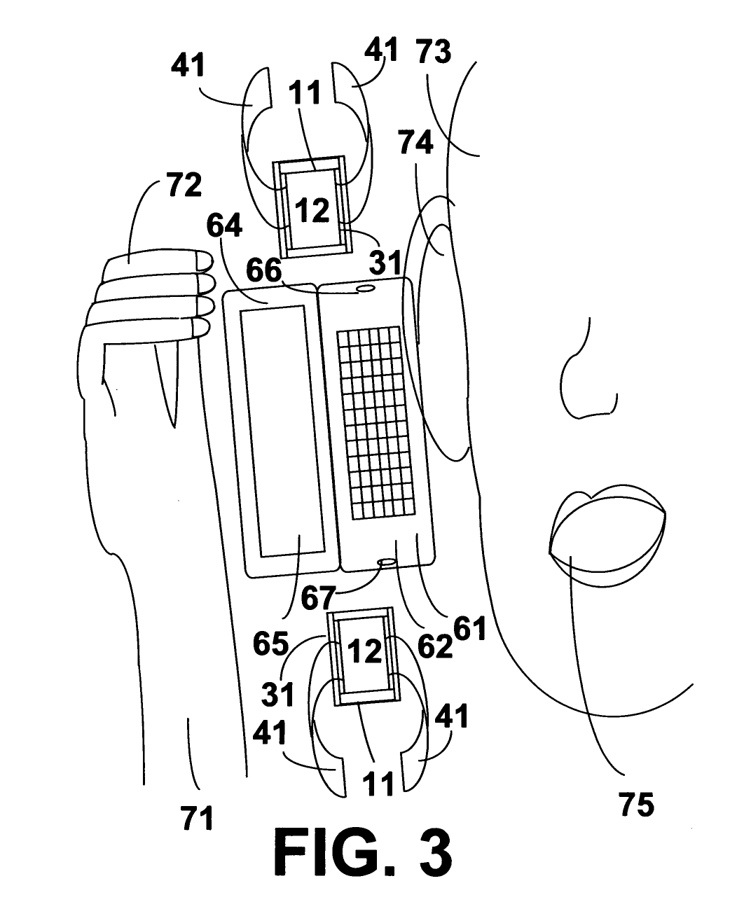

FIG. 3 shows an exploded view of a PDA 61 and attachable arm mounting brackets 11 with removable pins 14 for securing the multiple piece arm-bands 42 to the PDA. 61. Thereby the PDA 61 is mounted to the user's arm 71. The PDA 61 has two (2) arm mounting brackets 11 to better secure the PDA 61 to the user's arm 71. The PDA will typically be worn on the inside of the user's arm. 71 with the PDA front away from the user's arm 71. This allows the user to view the PDA display 63 directly. If the PDA has a flip-open display, the user can open the display to view it as well as use the data entry area. If the PDA has cell phone capability, the user can position the PDA next to his/her head for usage similar to how the cell phone is used in FIG. 2. Three or more arm mounting brackets 11 could be used to better secure the PDA 61 to the user's arm 71. Multiple arm mounting brackets 11 could also be used to secure a cell phone 51 to the users arm for rough duty use.

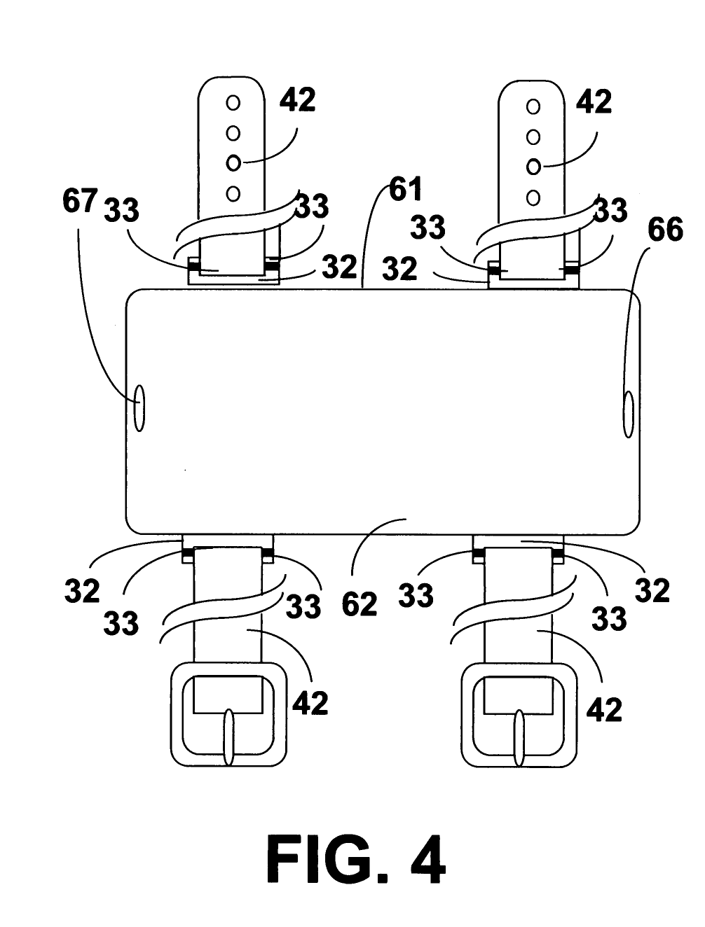

FIG. 4 shows a view of a PDA with arm mounting brackets attached directly to the PDA. The PDA 61 has two (2) permanently attached arm mounting brackets 21 to better secure the PDA 61 to the user's arm 71. FIG. 4 also shows how other devices similar in size to PDA's 61 such as GPS units, Palm Pilots, iPods, mini-computers, or other similarly sized devices could be attached to the user's arm 71 by means of multiple arm mounting brackets 11 or 21.

The arm mounting brackets for cell phones, PDA's and similar sized devices disclosed here allow user's to carry cell phones, cordless phones, and/or PDA's Palm Pilots, iPods, mini-computers and similar sized devices on their arms in a position that support easy usage. This degree of easy usage surpasses all prior art.

I claim:

1. An attachable arm mounting apparatus to attach to cell phones, PDA's and similar sized electronic devices to mount them to the user's wrist.
8. The apparatus of claim 1 wherein the arm mounting apparatus has a surface for attaching the apparatus to the back-side of a cell phone.
9. The apparatus of claim 1 wherein the arm mounting apparatus has a armband holder section without a removable pin that is designed to secure a wrist band to the holder.
10. The apparatus of claim 1 wherein the arm mounting apparatus has a armband holder section with a removable pin that is designed to secure a wrist band to the holder.
11. The apparatus of claim 7 wherein multiple copies of the arm mounting apparatus can be used together to secure PDA's, GPS units, mini computers, or similar sized devices to the user's arm.
12. The apparatus of claim 1 wherein the arm mounting apparatus can be positioned with the cell phone height aligned with the length of the user's arm so that the user can readily use the cell phone, cordless phone, PDA, Palm Pilot, Blackberry, minicomputer or similar sized device.
7. A permanently attached arm mounting apparatus integrated into the cell phone, cordless phone, PDA, ore similar sized electronic device to mount the device to the user's wrist.
8. The apparatus of claim 7 wherein the arm mounting apparatus has a armband holder section without a removable pin that is designed to secure a wrist band to the holder.
9. The apparatus of claim 7 wherein the arm mounting apparatus has a armband holder section with a removable pin that is designed to secure a wrist band to the holder.
10. The apparatus of claim 7 wherein multiple copies of the arm mounting apparatus can be used together to secure cell phones, cordless phones, PDA's, Palm Pilots, Blackberrys, GPS units, mini computers, or similar sized devices to the user's arm.
11. The apparatus of claim 7 wherein the arm mounting apparatus can be positioned so that the user's can readily use the cell phone, cordless phone, PDA, Palm Pilot, Blackberry, minicomputer or similar sized device.
